(19) United States
(12) Patent Application Publication
(10) Pub. No.: US 2013/0060900 A1
(43) Pub. Date: Mar. 7, 2013

(54) Method, Apparatus and System for Improving Synchronization Efficiency of Really Simple Syndication Service

(71) Applicants: Jianmei Li, Shenzhen (CN); Jian Shen, Shenzhen (CN); Lei Yuan, Shenzhen (CN); Feng Zhu, Shenzhen (CN)

(72) Inventors: Jianmei Li, Shenzhen (CN); Jian Shen, Shenzhen (CN); Lei Yuan, Shenzhen (CN); Feng Zhu, Shenzhen (CN)

(73) Assignee: ZTE CORPORATION, Shenzhen, Guangdong (CN)

(21) Appl. No.: 13/697,795

(22) PCT Filed: Aug. 16, 2010
(86) PCT No.: PCT/CN2010/076010

§ 371 Date: Nov. 13, 2012

(30) Foreign Application Priority Data
May 21, 2010 (CN) 201010183864.3

(51) Int. Cl. G06F 15/16

(52) U.S. Cl. 709/217

(57) ABSTRACT

The present invention discloses a method, apparatus and system for improving synchronization efficiency of Really Simple Syndication (RSS) service. The method comprises that: an RSS source server receiving and parsing a synchronization request packet sent from a mobile terminal, wherein the synchronization request packet comprises a last synchronization timestamp, then obtaining a last synchronization time; the RSS source server determining whether item contents in a channel are updated from the last synchronization timestamp to a current timestamp; if the item contents in the channel are not updated, the RSS source server sending synchronization data that only comprises a LINK label corresponding to an original item to the mobile terminal; and if the item contents in the channel are updated, the RSS source server adding the updated contents to the synchronization data and sending the synchronization data to the mobile terminal. The present invention can reduce the transmitted data quantity, thus shortening the synchronization time.

### FIELD OF THE INVENTION

The present invention relates to the communication technology field, and in particular to a method, apparatus and system for improving the synchronization efficiency of Really Simple Syndication (RSS) service.

### BACKGROUND OF THE INVENTION

RSS is a format standard of information source, and a simple method for one site to share contents with other sites, used to publish the websites that need regularly updating data, such as digest of Blog articles, news, audio messages or video messages, with the characteristics of diversification in sources, low cost for information publication, no rubbish information, convenient management on local contents and so on. It builds a technology platform on which information can be transmitted rapidly, making everyone a potential information provider. After a RSS file is published, the information included in this RSS file can be called by other sites, also could be used in other terminals and servers, for the data are in standard XML format. As more and more sites support RSS, RSS has become the most successful XML application at present. When users want to obtain information in certain networks by RSS, they do not need to obtain information from a website or a webpage one by one, in another word they do not have to login each website providing information; as long as they subscribed to the needed contents in one RSS reader, the contents will automatically appear in the user's RSS reader. Users can subscribe to the channels they need according to their own interests completely, update the contents at anytime, and view the latest messages, making it very convenient in use.

When the user terminal RSS reader updates the contents, the user terminal needs to send a synchronization request to the RSS source server, the RSS source server sends all the information in the channel to the terminal during the next synchronization, even in the situation that only a few items have been updated or no items have been updated, which causes the transmission redundancy of the data information, wherein the transmitting of the redundant information wastes the user's flow; the problem is particularly prominent especially when the above information includes media data (such as pictures, photos). Generally, in the process of the synchronization of the terminal with the server, the transmission time depends on the transmitted data quantity such that the larger the data quantity is, the longer the transmission takes; and the smaller the data quantity is, the shorter it takes. Doubtlessly, the approach of completely sending all the contents consumes a longer transmission time. Therefore, a method is needed to improve the synchronization efficiency, thus reducing the synchronization time, and enhancing the user's experience.

### SUMMARY OF THE INVENTION

The present invention provides a method, apparatus and system for improving synchronization efficiency of RSS service, to improve synchronization efficiency of RSS service and reduce synchronization time.

The present invention provides a method for improving synchronization efficiency of RSS Service, comprising the following steps:

an RSS source server receiving and parsing a synchronization request packet sent from a mobile terminal, wherein the synchronization request packet comprises a last synchronization timestamp, then obtaining a last synchronization time;

the RSS source server determining whether item contents in a channel are updated from the last synchronization time to a current time;

if the item contents in the channel are not updated, the RSS source server sending synchronization data that only comprises a LINK label corresponding to an original item to the mobile terminal; and

if the item contents in the channel are updated, the RSS source server adding the updated contents to the synchronization data and sending the synchronization data to the mobile terminal.

Preferably, the RSS source server adds a current synchronization timestamp to the synchronization data when sending the synchronization data.

Preferably, the steps, in which if the item contents in the channel are not updated, the RSS source server sending synchronization data that only comprises a LINK label corresponding to an original item to the mobile terminal; if the item contents in the channel are updated, the RSS source server adding the updated contents to the synchronization data and sending the synchronization data to the mobile terminal, comprising:

according to a determination that certain items are added to the channel, comprising complete contents of the added items into the synchronization data and then sending to the mobile terminal together with the current synchronization timestamp; and/or

according to a determination that contents of the original items are updated, comprising complete contents of the updated items into the synchronization data and then sending the synchronization data to the mobile terminal together with the current synchronization timestamp.

Preferably, the steps, in which if the item contents in the channel are not updated, the RSS source server sending synchronization data that only comprises a LINK label corresponding to an original item to the mobile terminal; if the item contents in the channel are updated, the RSS source server adding the updated contents to the synchronization data and sending the synchronization data to the mobile terminal, comprising:

according to a determination that certain items in the channel are deleted, filtering the deleted items' contents from the synchronization data and then sending the synchronization data to the mobile terminal together with the current synchronization timestamp.

A RSS source server, configured to receive a synchronization request packet sent from a mobile terminal, and send synchronization data to the mobile terminal according to the synchronization request packet, comprising:

a parsing unit, configured to parse the received synchronization request packet sent from the mobile terminal that comprises a last synchronization timestamp, and then obtain a last synchronization time;

a determination unit, configured to determine whether item contents in a channel have been updated from the last synchronization time to a current time; and

a synchronization data processing unit, comprising a LINK processing module and an updating processing module, the LINK processing module is configured to send the synchronization data that only comprises a LINK label corresponding to an original item to the mobile terminal according to a determination that the item contents in the channel are not updated; and the updating processing module is configured to add updated contents to the synchronization data and send the synchronization data to the mobile terminal according to a determination that the item contents in the channel are updated.

Preferably, the synchronization data processing unit further comprises:

a timnestamp adding module, configured to add a current synchronization timestamp when sending the synchronization data.

Preferably, the updating processing module comprises:

an incremental processing sub-module, configured to, according to a determination that certain items are added to the channel, comprise complete contents of the added items into the synchronization data and then send to the mobile terminal together with the current synchronization timestamp; and/or

an updating processing sub-module, configured to, according to a determination that contents of the original items are updated, comprise complete contents of the updated items into the synchronization data and then send the synchronization data to the mobile terminal together with the current synchronization timestamp.

Preferably, the updating processing module comprises:

a deleting item processing sub-module, configured to, according to a determination that certain items in the channel are deleted, filter the deleted items' contents from the synchronization data and then send the synchronization data to the mobile terminal together with the current synchronization timestamp.

A system for improving synchronization efficiency of RSS Service, comprising a mobile terminal and an RSS source server above, wherein the mobile terminal comprises a time marker unit and a communication unit, the time marker unit is configured to add a last synchronization timestamp to a synchronization request packet that are sent by the communication unit to an RSS source server, the communication unit is configured to receive synchronization data from the RSS source server according to the synchronization request packet.

A mobile terminal, which comprises a time marker unit and a communication unit, the time marker unit is configured to add a last synchronization timestamp to a synchronization request packet that are sent by the communication unit to an RSS source server, and the communication unit is configured to receive synchronization data from the RSS source server according to the synchronization request packet.

Preferably, the mobile terminal can further comprise a timestamp obtaining unit configured to parse and save the synchronization data comprising a current synchronization timestamp sent from the RSS source server.

The method, RSS source sever, mobile terminal and system for improving synchronization efficiency of RSS service provided in the present invention obtains the last synchronization time information and determines whether item contents in a channel are updated from the last synchronization timestamp to the current time before the RSS source server sending the synchronization data; if the item contents in the channel are not updated, the RSS source server sends synchronization data that only comprises a LINK label corresponding to an original item to the mobile terminal; and if the item contents in the channel are updated, the RSS source server adds the updated contents to the synchronization data and sending the synchronization data to the mobile terminal, but not the complete contents. Through this method, the transmitted data quantity can be reduced, thus shortening the synchronization time.

### BRIEF DESCRIPTION OF THE DRAWINGS

FIG. 1 is a flow chart of a method for improving synchronization efficiency of RSS service according to an embodiment of the present invention;

FIG. 2 is a flow chart of the method according to the above an embodiment, wherein the synchronization data are sent according to the updated contents;

FIG. 3 is a schematic view of a RSS source server structure according to an embodiment of the present invention;

FIG. 4 is a schematic view of the updating processing module structure in FIG. 3; and

FIG. 5 is a schematic view of a system for improving synchronization efficiency of RSS service according to an embodiment of the present invention;

The implementation, functional characteristics and advantages of the present invention object will be further illustrated hereinafter in conjunction with the embodiments and accompanying drawings.

### DETAILED DESCRIPTION OF THE EMBODIMENTS

It should be understood, the specific embodiment described here is just used to explain the present invention, not to limit the present invention.

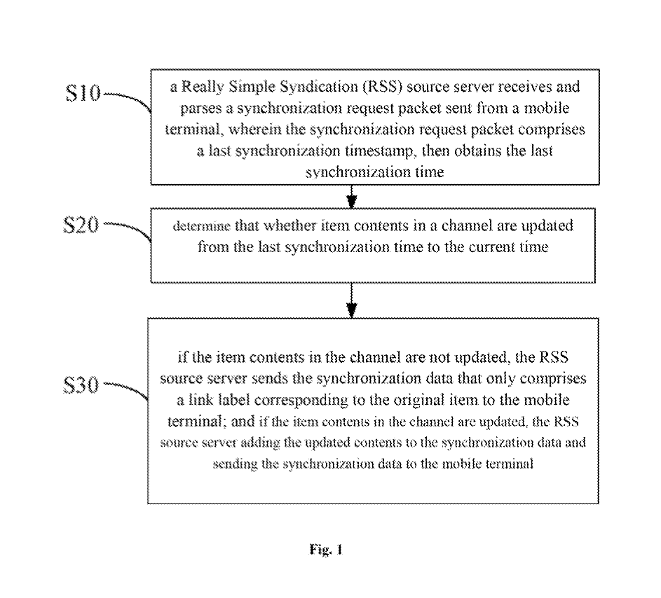

FIG. 1 shows a flow chart of a method for improving synchronization efficiency of RSS service according to an embodiment of the present invention, wherein the flow comprises:

step S10, the RSS source server receiving and parsing a synchronization request packet sent from a mobile terminal, wherein the synchronization request packet comprises a last synchronization timestamp, to obtain the last synchronization time. In the embodiment, the mobile terminal can be mobile phone or PDA etc. The timestamp format can be agreed on with the RSS source server, as long as it can be identified by both sides involved. In the embodiment, the mobile terminal can add a field LastSyncTime (the last synchronization time with the RSS source server, which can be also understood as the latest synchronization time with the RSS source server, that is, latestSyncTime) to the synchronization request packet, and write the timestamp information sent by the server during the last synchronization in the field (such as month:date:hour:minute), then send it to the RSS source server; the RSS source server parses the request packet to obtain the timestamp information in the field LastSyncTime, thus obtaining a last synchronization time.

Step S20, determining whether item contents in the channel are updated from the last synchronization time to the current time; in the embodiment above, the RSS source server can parse the synchronization packet to obtain the last synchronization time of month:date:hour:minute and determine whether item contents in the channel are updated from the last synchronization time to the present time of the current contents. For example, during the time period between January:1st:0:0 to January:2nd:8:0, the RSS source server determines whether the news web pages in a certain news channel are added or deleted, or the contents of the news web pages are updated etc.

Step S30, if the item contents in the channel are not updated, the RSS source server sending the synchronization data that only comprising a link label corresponding to the original item to the mobile terminal; and if the item contents in the channel are updated, the RSS source server adding the updated contents to the synchronization data and sending the synchronization data to the mobile terminal. In the embodiment, if the contents of the original web page are not changed, the RSS source server comprises the Link label of the web page into the synchronization data and sends them to the mobile terminal. The LINK label is a label of HTML language, and it can be used to create inter-linkage with external files. Specifically, the comparison between the data volume in the conventional technology and that in the synchronization data of the embodiment can refer to the following Synchronization data 1 and Synchronization data 2, wherein Synchronization data 1 is the complete contents of an item in the last synchronization data XML file in the conventional technology. In the conventional technology, during the synchronization, even if the last item contents are not changed, the last data are completely sent; in the embodiment, only the LINK label of the original item is comprised, as shown in Synchronization data 2:

Synchronization data 1:

<item readed=“1”>
<title>Denilson discards the CSL and joins in Vietnam, Luneng has

little chance for the Bicycle King</title>

<link>http://sports.sohu.com/20090602/n264294022.shtml</link>
<description><a
href=‘http://sports.sohu.com/20090602/n264294022.shtml’><img

src=‘http://photocdn.sohu.com/20090602/Img264294276_ss.jpg’
style=‘border:1px solid #000000;’/></a><description>Denilson has
once confronted Li Tie (information graph) June 2 (Beijing time), it
has been reported in Vietnam Youth Daily that, the former Brazil
NFL player Denilson who commanded the wind and the clouds in the
world soccer field contracts with Vietnam HaiPhong Cement, and
travels with the team for the Vietnam Professional League Match in
the second half year. Which means that the Brazil Bicycle King has
little chance to join in Shandong Luneng that has been reported by
some media before.</description>Denilson, who is now 31 years old, is
the famous master of dribbling in the world soccer field, and as the
member of Brazil 200... </description>

<category>the hot news in sports channels</category>
<author>sohu.com</author>
<pubDate>Tue, 02 Jun 2009 18:08:31 +0800</pubDate>
<comments>http://comment.news.sohu.com/comment/topic.jsp?i

d=264294022</comments>

<img path=“fs:/zrss/channels/101/Img265919776_ss.jpg” />
<img path=“fs:/zrss/channels/101/Img265919777_ss.jpg” />
<img path=“fs:/zrss/channels/101/Img265919778_ss.jpg” />
</item>

Synchronization data 2:

<item readed=“1”>

<link>http://sports.sohu.com/s2009/2802/s263988676/<link>

</item>

Therefore, the amount of Synchronization data 2 of incremental updating adopted in the embodiment is significantly less than that of Synchronization data 1 of complete updating in the conventional technology, wherein the effect is particularly significant when the items or the contents of the items are quite a lot, thus reducing the time of the data transmission, which can achieve the effect of improving the synchronization efficiency very well. In the communication systems which is charged by data flow, it saves the data flow cost for the users and enhances the user's experience.

In the embodiment, the step S30 can further comprise: adding a current synchronization timestamp to the synchronization data when sending the synchronization data. After the current synchronization timestamp is sent to the mobile terminal, the mobile terminal can comprise the timestamp into the synchronization request packet during the next synchronization and send the synchronization request packet to the RSS source server, which can further save the synchronization time.

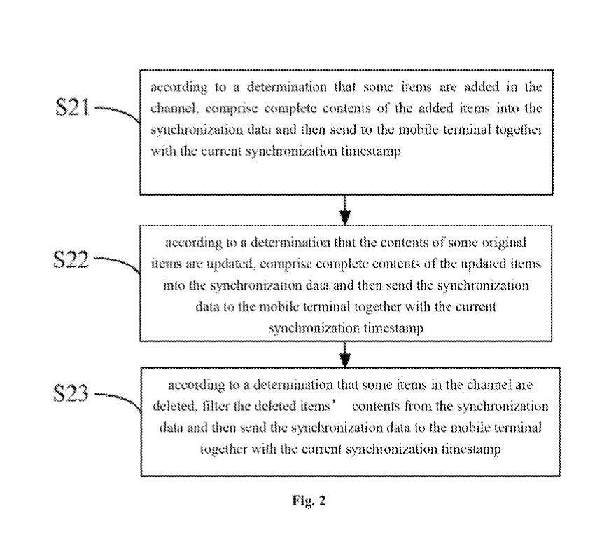

In the step S20, it can be determined that the contents of some items might be updated through the judgment, for example some items are added in the channel, the contents of certain item are updated or certain item is deleted etc. If some contents in the channel are updated, the embodiment can perform corresponding processing, as shown in FIG. 2, in an embodiment, the step S20 above can further comprise:

step S21, according to a determination that certain items are added to the channel, the complete contents of the synchronization data that comprises the added items together with the current synchronization timestamp are sent to the mobile terminal; in the embodiment, if during the last synchronization, the items comprised in the channel are A and B, the contents of the item A and B are not changed, but a new item C is added from the original synchronization time to the current time, then when sending the synchronization data, the RSS source server adds the complete contents of the item C to a XML file, and adds LINK labels to the item A and item B respectively, which are sent to the mobile terminal together with the current synchronization timestamp information.

Step S22, according to the determination that some item contents are updated, the complete contents of the synchronization data that includes the updated items together with the current synchronization timestamp are sent to the mobile terminal. In another embodiment, if the contents of the original item A are updated, for example, the contents of the item A are partly added, partly deleted etc., the complete contents after being updated together with the current synchronization timestamp are sent to the mobile terminal.

Step S23, according to the judgment that some item contents are deleted in the channel, the synchronization data that the item contents have been filtered together with the current synchronization timestamp to the mobile terminal. For example, in the embodiment, if the original item A does not exist anymore, then during this synchronization, the contents of the corresponding items in the synchronization data would be deleted.

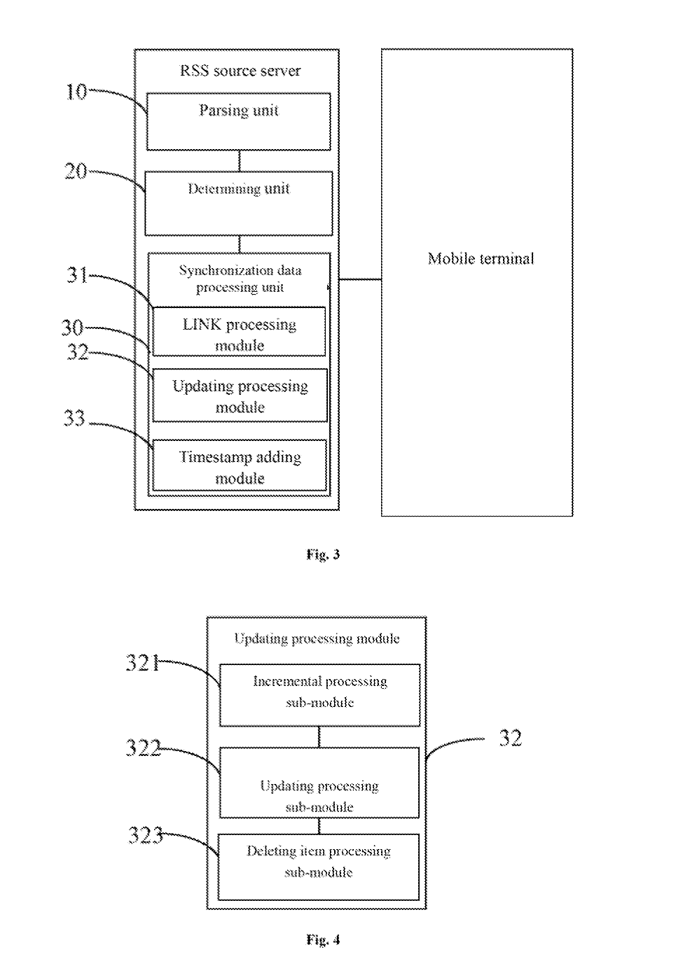

FIG. 3 shows the structure of a RSS source server according to an embodiment of the present invention. The RSS source server is configured to receive a synchronization request packet from a mobile terminal and send synchronization data to the mobile terminal according to the synchronization request packet.

The parsing unit 10 is configured to parse a synchronization request packet sent form a mobile terminal, wherein the synchronization request packet comprises a last synchronization timestamp, then obtain a last synchronization time; for example, in the embodiment above, the mobile terminal can add the field LastSyncTime to the request packet (the last synchronization time with the RSS source server), write the timestamp information in the field sent by the RSS source server during the last synchronization (such as month:date:hour:minute), send to the RSS source server; the source server parses the request packet, obtains the timestamp information in the field LastSyncTime, thus obtaining the last synchronization time.

The judgment unit 20 is configured to determine whether item contents in a channel are updated from the last synchronization time to the current time; in the embodiment, the RSS source server can parse the synchronization packet to obtain the last synchronization time of month:date:hour:minute, and determine whether item contents in the channel are updated from the last synchronization time to the time of the current contents. For example, during the time period between January:1st:0:0 to January:2nd:8:0, the RSS source server determines whether the news web pages in a certain news channel are added or deleted, or the contents of the news web pages are updated etc.

The synchronization data processing unit 30 comprises the LINK processing module 31 and the updating processing module 32, the LINK processing module 31 is configured to send the synchronization data that only comprises a LINK label corresponding to the original item to the mobile terminal according to a determination that the item contents in the channel are not updated; the updating processing module 32 is configured to add updated contents to the synchronization data and send the synchronization data to the mobile terminal according to a determination that the item contents in, the channel are updated. Please refer to the embodiment shown in Step S30 in FIG. 1 described above for the process of the synchronization data by LINK processing module 31. There would be no description in details herein.

In the embodiment, the RSS source server can determine whether the item contents in a channel are updated from the last synchronization time to the current time; if the item contents in the channel are not updated, the RSS source server sends the synchronization data that only includes a LINK label corresponding to the item; and if the item contents in the channel are updated, the RSS source server sends the updated contents, thus reducing the synchronization time, which can achieve the effect of improving the synchronization, efficiency very well and enhance the user's experience.

In the embodiment, the synchronization data processing unit 30 can also include the timestamp adding module 33 used to add the current synchronization timestamp when sending the synchronization data. After the current synchronization timestamp is sent to the mobile terminal, the mobile terminal can include the timestamp in the synchronization request packets during the next synchronization and send the synchronization request packets to the RSS source server, thus saving the synchronization time further.

As shown in FIG. 4, the updating processing module 32 above can comprise:

the incremental processing sub-module 321, configured to comprise complete contents of the added items into the synchronization data and then send to the mobile terminal together with the current synchronization timestamp according to a determination that certain items are added to the channel; and/or

the updating processing sub-module 322, configured to comprise complete contents of the updated items into the synchronization data and then send the synchronization data to the mobile terminal together with the current synchronization timestamp according to a determination that the contents of some original item are updated;

the deleting item processing sub-module 323, configured to comprise filter the deleted items' contents from the synchronization data and then send the synchronization data to the mobile terminal together with the current synchronization timestamp according to a determination that certain items in the channel are deleted.

Please refer to the embodiment shown in FIG. 2 as described above for the process of the synchronization data by the updating processing module 32.

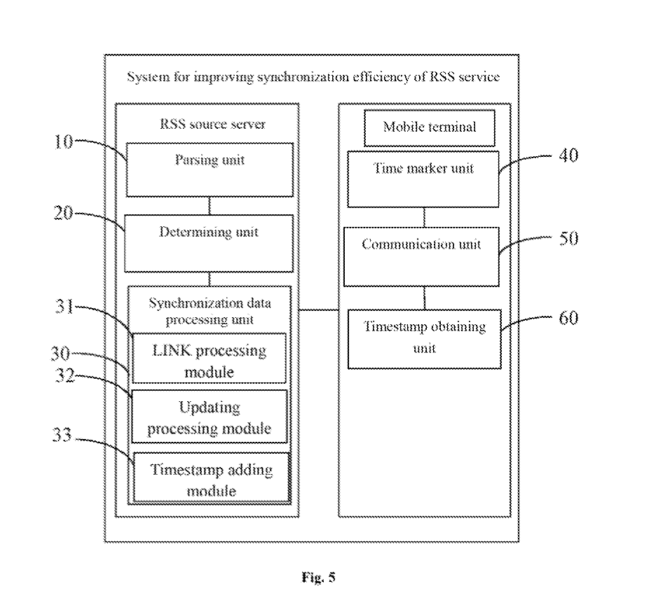

The embodiment further provides a mobile terminal, as shown in FIG. 5, which comprises a time marker unit 40 and a communication unit 50, wherein, the time marker unit 40 is configured to add the last synchronization timestamp to the synchronization request packet that are sent by the communication unit 50 to an RSS source server. The communication unit 50 is configured to receive the synchronization data sent by the RSS source server according to the synchronization request packet. In the embodiment, the time marker unit 40 can add the field LastSyncTime to the synchronization request packet (the last synchronization time with the RSS source server), and write the timestamp information in the field sent by the RSS source server during the last synchronization (such as month:date:hour:minute), so as to send to the RSS source server.

In the embodiment, the mobile terminal can further comprise a timestamp obtaining unit 60, configured to parse and save the synchronization data which comprises the current synchronization timestamp sent from the RSS source server. For example, when the RSS source server above sends the incremental synchronization data processed to the mobile terminal, the synchronization data processing unit can parse and save the incremental synchronization data, to obtain the synchronization data and save the current synchronization timestamp.

In the embodiment, the mobile terminal can be mobile communication terminal products such as mobile phone, PDA.

The embodiment further provides a system for improving synchronization efficiency of RSS service, which comprises the above mobile terminal and the above RSS source server.

The above is just the preferred embodiments of the present invention, not intended to limit the protection scope of the present invention. All the equivalent structure or the equivalent flow transfer which are made using the present invention specification and the accompanying drawings, the direct or the indirect application in other relevant technology fields are similarly all covered in the protection scope of the present invention.

What is claimed is:

1. A method for improving synchronization efficiency of RSS Service, comprising:
an RSS source server receiving and parsing a synchronization request packet sent from a mobile terminal, wherein the synchronization request packet comprises a last synchronization timestamp, then obtaining a last synchronization time;
the RSS source server determining whether item contents in a channel are updated from the last synchronization time to a current time;
if the item contents in the channel are not updated, the RSS source server sending synchronization data that only comprises a LINK label corresponding to an original item to the mobile terminal; and
if the item contents in the channel are updated, the RSS source server adding the updated contents to the synchronization data and sending the synchronization data to the mobile terminal.

2. The method for improving synchronization efficiency of RSS Service as claimed in claim 1, wherein,
the RSS source server adding a current synchronization timestamp to the synchronization data when sending the synchronization data.

3. The method for improving synchronization efficiency of RSS Service as claimed in claim 2, wherein,
the steps in which, if the item contents in the channel are not updated, the RSS source server sending synchronization data that only comprises a LINK label corresponding to an original item to the mobile terminal; if the item contents in the channel are updated, the RSS source server adding the updated contents to the synchronization data and sending the synchronization data to the mobile terminal, comprising:
according to a determination that certain items are added to the channel, comprising complete contents of the added items into the synchronization data and then sending to the mobile terminal together with the current synchronization timestamp; and/or
according to a determination that contents of the original items are updated, comprising complete contents of the updated items into the synchronization data and then sending the synchronization data to the mobile terminal together with the current synchronization timestamp.

4. The method for improving synchronization efficiency of RSS Service as claimed in claim 2, wherein,
the steps in which, if the item contents in the channel are not updated, the RSS source server sending synchronization data that only comprises a LINK label corresponding to an original item to the mobile terminal; if the item contents in the channel are updated, the RSS source server adding the updated contents to the synchronization data and sending the synchronization data to the mobile terminal, comprising:
according to a determination that certain items in the channel are deleted, filtering the deleted items' contents from the synchronization data and then sending the synchronization data to the mobile terminal together with the current synchronization timestamp.

5. A RSS source server, configured to receive a synchronization request packet sent from a mobile terminal, and send synchronization data to the mobile terminal according to the synchronization request packet, comprising:
a parsing unit, configured to parse the received synchronization request packet sent from the mobile terminal that comprises a last synchronization timestamp, and then obtain a last synchronization time;
a determination unit, configured to determine whether item contents in a channel have been updated front the last synchronization time to a current time; and
a synchronization data processing unit, comprising a LINK processing module and an updating processing module, the LINK processing module is configured to send the synchronization data that only comprises a LINK label corresponding to an original item to the mobile terminal according to a determination that the item contents in the channel are not updated; and the updating processing module is configured to add updated contents to the synchronization data and send the synchronization data to the mobile terminal according to a determination that the item contents in the channel are updated.

6. The RSS source server as claimed in claim 5, wherein the synchronization data processing unit further comprises:
a timestamp adding module, configured to add a current synchronization timestamp when sending the synchronization data.

7. The RSS source server as claimed in claim 5, wherein the updating processing module comprises:
an incremental processing sub-module, configured to, according to a determination that certain items are added to the channel, comprise complete contents of the added items into the synchronization data and then send to the mobile terminal together with the current synchronization timestamp; and/or
an updating processing sub-module, configured to, according to a determination that contents of the original items are updated, comprise complete contents of the updated items into the synchronization data and then send the synchronization data to the mobile terminal together with the current synchronization timestamp.

8. The RSS source server as claimed in claim 5, wherein the updating processing module comprises:
a deleting item processing sub-module, configured to, according to a determination that certain items in the channel are deleted, filter the deleted items' contents from the synchronization data and then send the synchronization data to the mobile terminal together with the current synchronization timestamp.

9. A mobile terminal, comprising a time marker unit and a communication unit, wherein the time marker unit is configured to add a last synchronization timestamp to a synchronization request packet that are sent by the communication unit to an RSS source server and the communication unit is configured to receive synchronization data from the RSS source server according to the synchronization request packet.

10. The mobile terminal as claimed in claim 9, wherein the mobile terminal further comprises a timestamp obtaining unit, configured to parse and save the synchronization data comprising a current synchronization timestamp sent from the RSS source server.

11. (canceled)

12. A system for carrying out the method for improving synchronization efficiency of RSS Service as claimed in claim 1, wherein the system comprises the RSS source server and the mobile terminal,
wherein the RSS source server comprises:
a parsing unit, used to parse the received synchronization request packets and obtain the last synchronization timestamp;
a determination unit, used to determine whether the item contents in the channel have been updated from the last synchronization timestamp to the current timestamp; and
a synchronization data processing unit, comprising a LINK processing module and an updating processing module, the LINK processing module used to send the synchronization data that only comprises the LINK label corresponding to the original item to the mobile terminal according to a determination that the item contents in the channel are not updated; and the updating processing module used to add the updated contents to the synchronization data and send the synchronization data to the mobile terminal according to a determination that the item contents in the channel are updated,
wherein the mobile terminal comprises a time marker unit and a communication unit, wherein the time marker unit is used to add the last synchronization timestamp to synchronization request packets that are sent by the communication unit to the RSS source server and the communication unit is used to receive the synchronization data from the RSS source server according to the synchronization request packets.

13. The system as claimed in claim 12, wherein the synchronization data processing unit of the RSS source server also comprises: a timestamp adding module, used to add the current synchronization timestamp when sending the synchronization data.

14. The system as claimed in claim 12, wherein the updating processing module of the synchronization data processing unit comprises:
an incremental processing sub-module, used to, according to a determination that certain items are added to the channel, comprise complete contents of the added items into the synchronization data and then send to the mobile terminal together with the current synchronization timestamp; and/or
an updating processing sub-module, used to, according to a determination that contents of the original items are updated, comprise complete contents of the updated items into the synchronization data and then send the synchronization data to the mobile terminal together with the current synchronization timestamp.

15. The system as claimed in claim 12, wherein the updating processing module of the synchronization data processing unit comprises: a deleting item processing sub-module, used to, according to a determination that certain items in the channel are deleted, filter the deleted items' contents from the synchronization data and then send the synchronization data to the mobile terminal together with the current synchronization timestamp.

16. The system as claimed in claim 12, wherein the mobile terminal comprising a timestamp obtaining unit used to parse and save the synchronization data comprising the current synchronization timestamp sent from the RSS source server.
